(19) United States
(12) Patent Application Publication
(10) Pub. No.: US 2009/0218877 A1
(43) Pub. Date: Sep. 3, 2009

(54) DEVICE FOR BREAKING SOLID MATERIAL AND METHOD OF MANUFACTURING A HOSE ELEMENT FOR SUCH A DEVICE

(75) Inventors: Karl Gustaf Derman, Harestad (SE); Lennart Derman, Kärna (SE)

Correspondence Address: BROOKS KUSHMAN P.C., 1000 TOWN CENTER, TWENTY-SECOND FLOOR, SOUTHFIELD, MI, 48075, US

(73) Assignee: EMSTONE AB, Lund (SE)

(21) Appl. No.: 12/279,439

(22) PCT Filed: Feb. 15, 2007
(86) PCT No.: PCT/SE2007/000138

§ 371 Date: Dec. 22, 2008

(30) Foreign Application Priority Data
Feb. 15, 2006 (SE) 0600329-7

(51) Int. Cl. E21C 37/10; B23P 11/00

(52) U.S. Cl. 299/21; 29/446

(57) ABSTRACT

A device for breaking solid material comprises an expansible hose element which is insertable into a hole in the solid material and has an externally substantially geometrically regular cross-section. At least at one of its ends, the hose element comprises a coupling. The device further comprises at least one expansion portion with an expansion chamber. The hose element further comprises an expansion limiter which has a varying radial distance from the outside of the hose element along the circumferential direction of the hose element.

### TECHNICAL FIELD

The present invention relates to a device for breaking solid material, comprising an expansible hose element which is insertable into a hole in the solid material and has an externally substantially geometrically regular cross-section, said hose element comprising a coupling at least at one of its ends, the device further comprising at least one expansion portion with an expansion chamber. The invention also relates to a method of manufacturing a hose element according to that stated above.

### TECHNICAL BACKGROUND

It has for a long time been a great challenge to find a way of cracking rock, stone, concrete and the like in a simple, cheap, quick and environmentally friendly way, while obtaining a predetermined directed expansive force.

The breaking of solid materials, such as stone, rock, concrete and the like, can be carried out by drilling one or more holes in the material and by expanding the hole to such a degree that the surrounding material cracks. In this connection, the hole can be expanded by an explosive inserted in the hole being caused to explode. However, this method is of limited use, owing to the resultant vibrations, the loud noise and the generally high risks, making it necessary to involve specially trained personnel for the work, and it cannot be used, for instance, in densely built-up areas without great risks or can only be used to a very small extent. Furthermore, the handling of explosives constitutes a great problem due to the security risks, not only of unintended ignition but also of theft and use of the explosives in illegal operations. It is also known to obtain the expansion of the drill hole required for breaking the material in other ways than by detonation of explosives. It is, for instance, known to fill the drill hole with a cement solution having the capacity to expand during curing to such a degree and with such force that the material is caused to break. There are, however, important disadvantages of this method, such as the cement being expensive and the breaking taking about 24 hours to perform. It is also known to obtain the expansion of the drill hole required for the breaking by unsealing the orifice of the hole and supplying high-pressure water to the drill hole. This method requires complicated and expensive devices and may cause problems as the drill hole has to be made absolutely tight before the water is supplied, which means that any cracks in the walls of the drill hole have to be sealed before the breaking can be performed.

Patent specification SE 8405218 2 discloses a device adapted for breaking stone blocks and rock, which is designed as a cylindrical tube with an expansible wall transversely to the longitudinal direction of the tube and with axially arranged end portions, which are held together by a tie rod in the form of a rod, a tube or a wire arranged in the cylindrical tube. In addition, this device is provided with a number of sealing elements for sealing the pressure chamber formed by the cylindrical tube between the end portions. In tests, it has also been found that the capsule formed by the pressure chamber has the disadvantage of often splitting into pieces, in particular when the broken material splits or a piece of rock comes off and the capsule is partly uncovered and the pressurisation of the capsule is maintained to make the rock continue to split. It has been found that in this situation the capsule easily bursts since the surrounding material has disappeared. This increases the costs as the capsule has to be replaced and, in addition, environmental problems arise since the used fluid is often oil which is released into the environment if the capsule bursts, thereby causing cleaning problems with the collecting of the oil.

Patent specification SU 1051 269 A discloses an invention comprising two non-rigid metallic pressure surfaces which are adapted to press against the surface of the drill hole. At the ends, two metal clips are arranged which are intended to make the metal bars return to their initial position after being pressed out. It is obvious that this will not work since the metal bars, after being pressed out, will remain in their bent position, in particular at the couplings of the clips.

### SUMMARY OF THE INVENTION

The object of the present invention is to provide an expansion device for breaking solid material, such as stone, rock, concrete and the like, in which the drawbacks stated above have been eliminated and by means of which it is thus possible to quickly, simply and cheaply expand drill holes made in stone, rock, concrete or the like to such a degree that the material surrounding the drill holes is caused to break with a directed explosive force.

This object is achieved by a device for breaking solid material, comprising an expansible hose element which is insertable into a hole in the solid material and has an externally substantially geometrically regular cross-section, said hose element comprising a coupling at least at one of its ends, the device further comprising at least one expansion portion with an expansion chamber. The hose element further comprises an expansion limiter which has a varying radial distance from the outside of the hose element along the circumferential direction of the hose element. The expansion limiter has the advantage of making the hose expand along its entire length whether there is a surrounding resistance or not, i.e. whether a piece of, for instance, the rock in which the hose is arranged splits or not. Furthermore, it makes it possible to insert only part of the hose element into a drill hole. The term “expansion portion” refers to the portion or portions that are arranged radially inwardly of the expansion limiter. In some embodiments of the hose element, there is only one expansion chamber inwardly of the expansion limiter.

The term “solid material” refers to a material which is in solid state at normal outdoor temperatures, such as rock and concrete.

In one embodiment, the cross-section of the expansion chamber is such that the relationship between the longest distance between the walls and the shortest distance decreases as the hose element changes from an unpressurised to a pressurised state. In the unpressurised state, the expansion chamber thus has a non-circular cross-section, the expansion chamber being arranged to aim at a circular cross-section when pressurised. Since the hose element externally has a geometrically regular cross-section in the unpressurised state, the pressurisation makes the hose element expand in a direction parallel with the line that represents the shortest distance between two opposite walls in the expansion chamber in the unpressurised state. The term “geometrically regular cross-section” primarily refers to a circular cross-section but it also includes equilateral polygons and other forms having some kind of regularity in their circumferential shape.

Preferably, the hose element externally has a substantially cylindrical shape in the unpressurised state. Holes drilled in rock, for instance, mostly have a circular cross-section, and the hose element preferably has a complementary shape.

In one embodiment, the hose element has a built-in reinforcement.

Preferably, the hose element is flexible in those cases where the holes in the material that is to be broken are not straight.

Suitably, a hose element is selected according to a pressure table so that the hose will resist a higher pressure than can be supplied by the pump device used in connection with this hose.

A method of manufacturing a hose element according to the invention suitably comprises the steps of positioning a hydraulic hose with a substantially circular cross-section between two parallel flat surfaces, moving the two flat surfaces towards each other so that the hose is pressed so as to obtain two substantially flat surfaces, and applying material to the hose so as to give it an externally substantially geometrically regular cross-section.

Preferably, when manufacturing the ends of the hose element, after the flattened part, the ends are not made longer than required so that conventional hydraulic couplings can be applied to the hose element.

Here follows a description of how an embodiment of the expansion device with an expansion chamber can be designed to obtain the pressure-generating part of the hose element and, in combination with a suitable design, transmit the result to a directed expansion device. At one end of the hose element, a coupling device is arranged to allow the incoming fluid to enter the expansion chamber of the hose element, and in the other end of the hose element an end coupling is arranged, in which a hole is suitably also made so that some kind of adapter can be connected to enable one or more expansion directing means to be interconnected so that they together can generate a long pressure effect, for instance in case of a long drill hole, or be laterally interconnected. To make it possible to use only one expansion means, an end plug is arranged which seals the expansion means so as to stop fluid from leaking.

Means are applied by curing or some other suitable method to the substantially flat outer surfaces of the hose element so that the element obtains the intended shape. In this embodiment, the means have such a shape that the final result is a rounded shape adapted to be inserted in a drill hole. Around the entire expansion means or a suitable portion thereof, an expansible but also contracting casing is suitably arranged by curing, which casing in cooperation with the motion of the hose element is intended to keep together and also protect and above all help the expansion means to return to its initial shape when the pressure in the expansion chamber of the hose element has stopped.

### BRIEF DESCRIPTION OF FIGURES

In the following, the invention will be described in more detail with reference to the accompanying figures.

FIG. 1 is a cross-sectional view seen along the longitudinal axis of the expansion device.

FIG. 2a is a cross-sectional view of a hose element in an unpressurised state according to an embodiment of the invention.

FIG. 2b is a cross-sectional view of the hose element in FIG. 2a in a pressurised state and illustrates how, for instance, rock is split.

FIG. 3 is a perspective view of the hose element.

FIG. 4 is a perspective view of a sectioned part from FIG. 3.

FIG. 5 is an enlarged cross-sectional view of the coupling part of the expansion device.

FIG. 6 is an enlarged cross-sectional view of the end coupling of the expansion device.

FIGS. 7a and 7b are cross-sectional views of a hose element according to an alternative embodiment in an unpressurised and a pressurised state, respectively.

FIGS. 8a and 8b are cross-sectional views of a hose element according to yet another alternative embodiment in an unpressurised and a pressurised state, respectively.

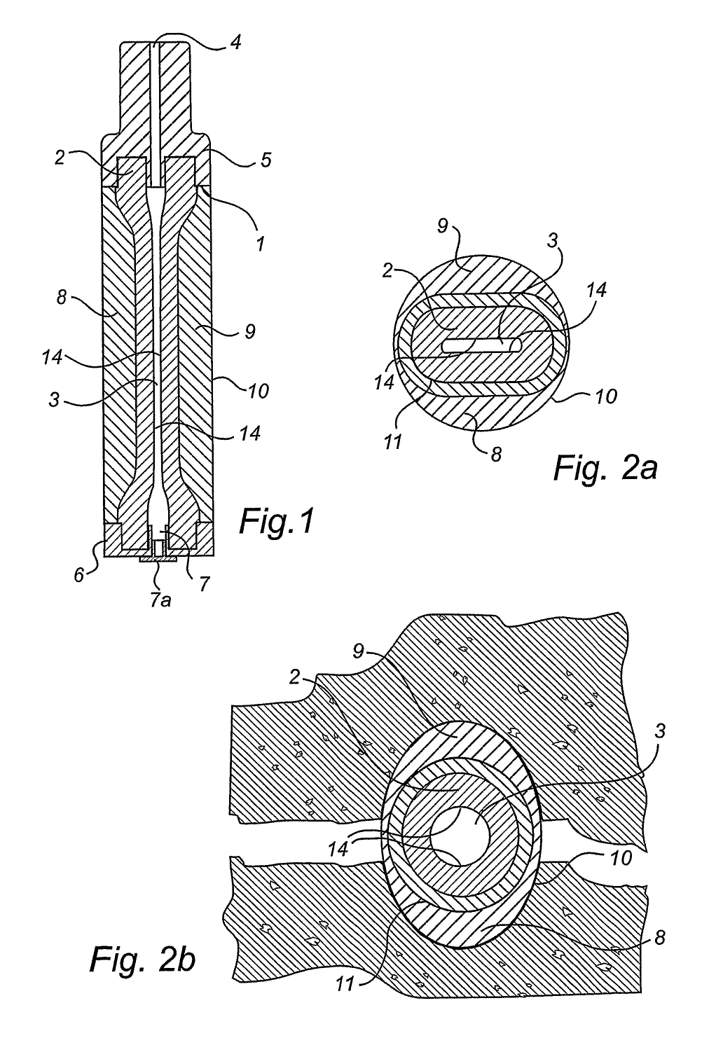

### DESCRIPTION OF PREFERRED EMBODIMENTS

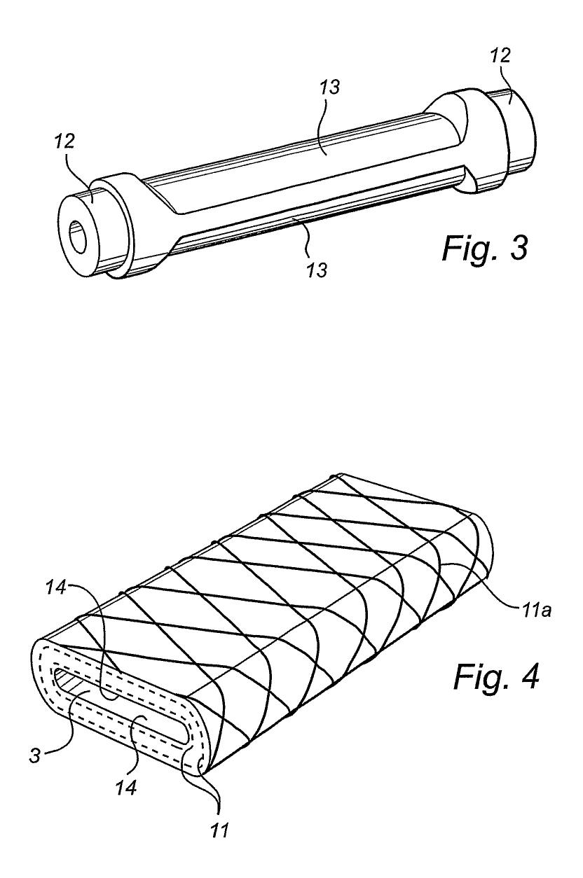

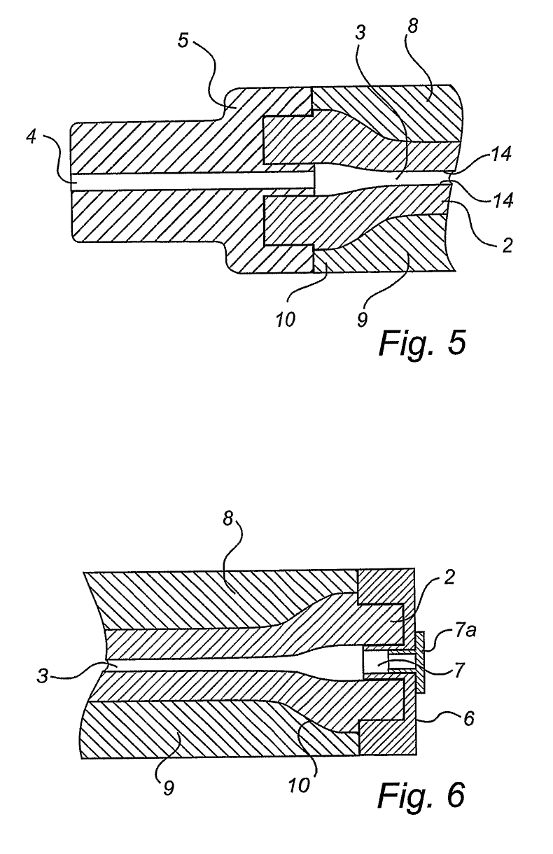

FIG. 1 shows a device 1, comprising a hose element 2 made of preferably a conventional reinforced hydraulic hose which in its centre portion, seen in the longitudinal direction, is flattened so as to form an expansion chamber 3, which has one or more inner pressure surfaces 14. These broad pressure surfaces 14, which act outwardly seen from the longitudinal axis of the hose element 2 and form the directed pressing part of the hose element 2, generate a high pressure in the initial phase which successively decreases as the hose element 2 returns to a rounded, substantially cylindrical shape. At one of its ends, the hose element 2 has a coupling 5 connected to a pressure source (not shown) from which fluid enters through the opening 4 of the expansion chamber 3 to be subsequently stopped by a coupling 6, which constitutes the stop for the fluid but can be opened if a plug 7a is removed from the opening of the coupling 7. This makes it possible to connect more than one expansion device 1 in series with each other. With one or more suitable coupling devices, a chain of expansion devices 1 can thus be caused to cooperate both in the longitudinal and the lateral direction. On the “flat” outer surfaces 13 (FIG. 3) of the hose element 2, preferably elliptical pressure means 8 and 9 are arranged by curing or in some other suitable way, so that the hose element 2 obtains a shape which closely follows the drill hole in which the device is to be used. In this embodiment, the means 8, 9 are elliptical so that the final result will be a rounded flexible shape which can be fitted into a drill hole that is not absolutely straight. The contour of the device can also have some other shape if it is to be used in an application in which the drill hole is not round. The expansion device can, for instance, be cast in advance, for instance, in concrete.

Around the entire expansion device 1 or a suitable portion thereof, an expansible but also contracting casing 10 is arranged, preferably by curing, which casing, in cooperation with the motion of the hose element 2, is to keep together and also protect the expansion device 1 and above all help it to return to its initial shape when the pressure in the expansion chamber 3 of the hose element 2 has stopped. The design of the expansion device 1 and the use of a reinforced pressure hose as hose element 2 also offer the advantage that the part that is outside the edge of the drill hole in the rock expands first since the resistance is greater in the hole than outside the hole, i.e. the hose element 2 expands more outside the edge of the hole than inside the same until the reinforcement 11 of the hose element 2 resists the pressure. The expansion device 1 thus grows bigger outside the hole in the rock than inside, whereby a wedge-shaped force is produced between the expansion device 1 and the edge of the hole. This advantage is doubled if the expansion device is allowed to project on both sides of a through hole in the rock.

It is possible to let the splitting of the cracked material continue since the expansion of the capsule can proceed by allowing the hydraulic hose to expand until the inner hole is completely round. When the hole in the hydraulic hose is completely round, the hose cannot expand any more since the reinforcement of the hydraulic hose then resists the inner pressure.

The problems described in connection with SE 8405218-2 are eliminated by the present invention as the expansion capsule is made of a conventionally reinforced hydraulic hose, which is selected so as to resist a higher pressure than can be generated by the pump supplying the pressure medium. Owing to this, there is no need for interior tie rods since the reinforcement in the wall of the hydraulic hose holds together the end portions, and the couplings at both ends are tight and do not need any additional sealing.

By allowing part of the expansion device 1 to be placed outside a drill hole, a greater expansion force is obtained in the drill hole since in that case there is no end portion to reduce the breaking area.

If the drilling is performed straight through the rock, it is also possible to allow the expansion device to project on both sides since in that case there is no loss of expansion force as there is no end portion to reduce the expansion force.

The use of a conventionally reinforced pressure hose as a hose element 2 in the expansion device 1 also presents the advantage that it is possible to manufacture long lengths of the expansion device 1, which makes it easy to handle the expansion device as it can be wound up for transport to the next site of use.

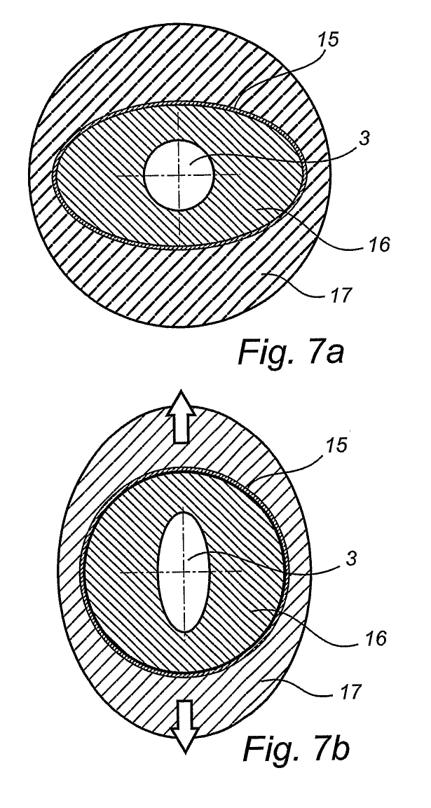

FIGS. 7a and 7b show an alternative embodiment of the present invention. In this case, the expansion chamber 3 is substantially circular in cross-section in the unpressurised state, and when pressurised, it expands as much as allowed by the expansion limiter 15. The expansion limiter 15 aim at a cylindrical shape when pressurised. This causes the hose element to expand somewhat in two opposite directions (vertically in FIG. 7b) and simultaneously decrease perpendicularly to these directions (horizontally in FIG. 7a). Preferably, the hose portions 16 and 17 are made of an elastic material with limited compressibility, such as rubber. It is, of course, possible to use the same material for both hose portions or to use different materials.

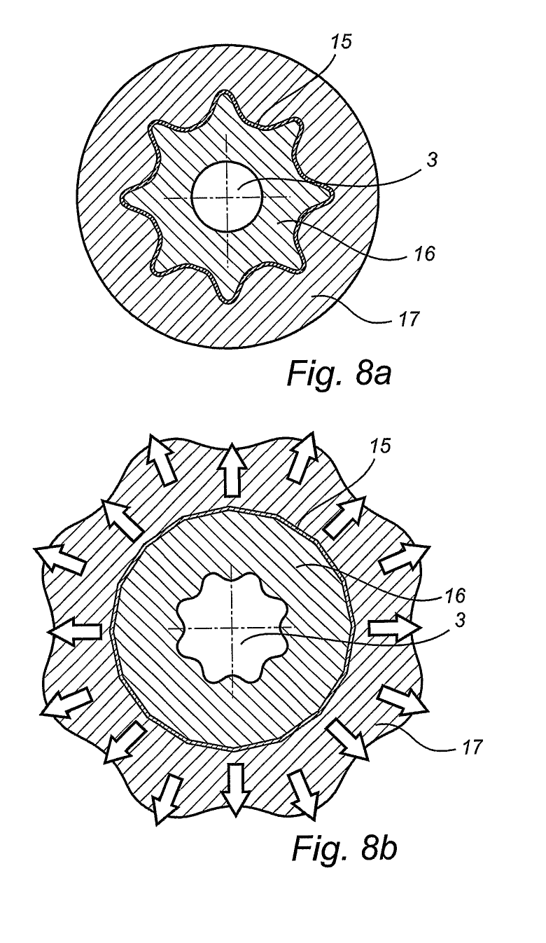

FIGS. 8a and 8b show yet another alternative embodiment of the present invention. In FIG. 8a, the hose element is in an unpressurised state, in which case the expansion limiter 15 has a star-like shape. In this embodiment, the explosive force is produced in eight directions evenly distributed along the circumference. As the hose element expands evenly along the circumference, the friction is reduced between the material that is to be cracked/broken and the hose element, the latter consequently being subjected to less wear while having a longer service life.

It will be understood that a number of modifications are possible within the scope of the invention such as defined by the appended claims. For example, a plurality of expansion chambers may be used in a hose element to increase the explosive force in some direction or, alternatively, to obtain an explosive force in more than two directions. Furthermore, some dimensions in the figures are exaggerated to further clarify the inventive idea.

1. A device for breaking solid material, comprising an expansible hose element which is insertable into a hole in the solid material and has an externally substantially geometrically regular cross-section, said hose element comprising a coupling at least at one of its ends, the device further comprising at least one expansion portion with an expansion chamber wherein the hose element further comprises an expansion limiter which has a varying radial distance from the outside of the hose element along the circumferential direction of the hose element.

2. A device as claimed in claim 1, in which the cross-section of the expansion chamber is such that the relationship between the longest distance between the walls and the shortest distance decreases as the hose element changes from an unpressurised to a pressurised state.

3. A device as claimed in claim 1, in which the hose element externally has a substantially cylindrical shape in the unpressurised state.

4. A device as claimed in claim 1, in which said expansion limiter in the hose element is a reinforcement built into the hose element.

5. A device as claimed in claim 1, in which the hose element is flexible.

6. A method of manufacturing a hose element, comprising the steps of positioning a hydraulic hose with a substantially circular cross-section between two parallel flat surfaces, moving the two flat surfaces towards each other so that the hydraulic hose is pressed so as to obtain two substantially flat surfaces, applying material to the hydraulic hose so as to give it an externally substantially geometrically regular cross-section.

7. A device as claimed in claim 2, in which the hose element externally has a substantially cylindrical shape in the unpressurised state.

8. A device as claimed in claim 2, in which said expansion limiter in the hose element is a reinforcement built into the hose element.

9. A device as claimed in claim 3, in which said expansion limiter in the hose element is a reinforcement built into the hose element.

10. A device as claimed in claim 7, in which said expansion limiter in the hose element is a reinforcement built into the hose element.

11. A device as claimed in claim 2, in which the hose element is flexible.

12. A device as claimed in claim 3, in which the hose element is flexible.

13. A device as claimed in claim 4, in which the hose element is flexible.

14. A device as claimed in claim 7, in which the hose element is flexible.

15. A device as claimed in claim 8, in which the hose element is flexible.

16. A device as claimed in claim 9, in which the hose element is flexible.
